(19) United States
(12) Patent Application Publication
(10) Pub. No.: US 2023/0154168 A1
(43) Pub. Date: May 18, 2023

(54) IMAGE RECOGNITION SYSTEM, EVALUATION DEVICE, AND IMAGE RECOGNITION METHOD

(71) Applicant: Fujitsu Limited, Kawasaki-shi (JP)

(72) Inventor: Xuying LEI, Kawasaki (JP)

(73) Assignee: Fujitsu Limited, Kawasaki-shi (JP)

(21) Appl. No.: 17/890,269

(22) Filed: Aug. 18, 2022

(30) Foreign Application Priority Data
Nov. 12, 2021 (JP) 2021-184635

(51) Int. Cl. G06V 10/776; G06V 10/82; G06V 10/77; G06V 10/28

(52) U.S. Cl. CPC G06V 10/776; G06V 10/82; G06V 10/7715; G06V 10/28

(57) ABSTRACT

An image recognition system includes at least one memory, and at least one processor coupled to the at least one memory, respectively, and configured to perform a first process, for an image inputted, up to a dividing position determined in a DNN, and output feature-maps of the image, compress the outputted feature-maps, and transmit the compressed feature-maps, receive and reconstruct the compressed feature-maps, and perform a recognition process, for the reconstructed feature-map inputted, after the dividing position, and output a recognition result, wherein the dividing position is determined by accuracy of the recognition result and a total time that includes a time for the performing of the first process, a time for the compressing of the outputted feature-maps, a time for the transmitting of the compressed feature-maps, a time for the reconstructing of the compressed feature-maps, and a time for the performing of the recognition process.

### CROSS-REFERENCE TO RELATED APPLICATION

This application is based upon and claims the benefit of priority of the prior Japanese Patent Application No. 2021-184635, filed on Nov. 12, 2021, the entire contents of which are incorporated herein by reference.

### FIELD

The embodiments discussed herein are related to an image recognition system, an evaluation device, and an image recognition method.

### BACKGROUND

Commonly, in the transmission of image data, the transmission cost is reduced by making the data size smaller by a compression process.

There are a variety of methods for performing a compression process on image data and transmitting the compressed image data. As an example, a method may be mentioned in which the processes from an input layer to an intermediate layer of a deep neural network (DNN) model is performed by an edge device, and the deep feature maps output from the intermediate layer are transmitted to a cloud device.

According to the transmission method, the transmission cost may be reduced, and besides, by distributing the DNN model to the edge device and the cloud device to perform processes, an image recognition system that performs a low-delay recognition process on image data may be implemented.

Here, in the case of the image recognition system by the above transmission method, in order to implement the low-delay recognition process, it is desired to appropriately determine to what position in the intermediate layer the edge device is in charge of the processes (for example, the dividing position when the DNN model is divided to the edge device and the cloud device). In regard to this, for example, it is disclosed that the dividing position is determined based on the amount of data of deep feature maps output from each layer and the amount of computation in each layer.

Japanese Laid-open Patent Publication No. 2021-120846, Japanese Laid-open Patent Publication No. 2020-92329, and International Publication Pamphlet No. WO 2020/116451 are disclosed as related art. Yiping Kang, Johann Hauswald, Cao Gao, Austin Rovinski, Trevor Mudge, Jason Mars, Lingjia Tang, “Neurosurgeon Collaborative Intelligence Between the Cloud and Mobile Edge”, 4 Apr., 2017 is also disclosed as related art.

### SUMMARY

According to an aspect of the embodiments, an image recognition system includes at least one memory, and at least one processor coupled to the at least one memory, respectively, and configured to perform a first process, for an image inputted, up to a dividing position determined in a deep neural network (DNN), and output feature maps of the image, compress the outputted feature maps, and transmit the compressed feature maps, receive and reconstruct the compressed feature maps, and perform a recognition process, for the reconstructed feature map inputted, after the dividing position, and output a recognition result, wherein the dividing position is determined by accuracy of the recognition result and a total time that includes a time for the performing of the first process, a time for the compressing of the outputted feature maps, a time for the transmitting of the compressed feature maps, a time for the reconstructing of the compressed feature maps, and a time for the performing of the recognition process.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for explaining an outline of a recognition process by an image recognition system;

FIGS. 2A to 2C are diagrams illustrating an example of the system configuration of the image recognition system in each phase;

FIGS. 3A and 3B are diagrams illustrating an example of the hardware configuration of each device of the image recognition system;

FIG. 4 is a diagram illustrating an example of the functional configuration of a generation device;

FIG. 5 is a diagram for explaining the dividing positions of a DNN model;

FIG. 6 is a diagram illustrating an example of the functional configuration of an evaluation device;

FIG. 7 is a first diagram illustrating details of a functional configuration of an autoencoder (AE) learning unit;

FIG. 8 is a diagram illustrating an example of the functional configuration of a time evaluation unit;

FIG. 9 is a flowchart illustrating a flow of a generation process by the generation device;

FIG. 10 is a first flowchart illustrating a flow of an evaluation process by the evaluation device;

FIG. 11 is a first flowchart illustrating a detailed flow of a learning process for a processing system n;

FIG. 12 is a first diagram illustrating an example of the functional configuration of an edge device and a cloud device;

FIG. 13 is a first flowchart illustrating a flow of a compression/reconstruction/recognition process by the edge device and the cloud device;

FIG. 14 is a diagram illustrating an application example of the image recognition system;

FIG. 15 is a diagram illustrating a specific example of a process of a divisible position specifying unit;

FIG. 16 is a second diagram illustrating details of a functional configuration of an AE learning unit;

FIG. 17 is a second flowchart illustrating a flow of an evaluation process by an evaluation device;

FIG. 18 is a second flowchart illustrating a detailed flow of a learning process for the processing system n;

FIG. 19 is a second diagram illustrating an example of the functional configuration of an edge device and a cloud device; and

FIG. 20 is a second flowchart illustrating a flow of a compression/reconstruction/recognition process by the edge device and the cloud device.

### DESCRIPTION OF EMBODIMENTS

Depending on the configuration of an image recognition system, a low-delay recognition process sometimes may not be implemented only by considering the amount of data of deep feature maps output from each layer and the amount of computation in each layer.

Hereinafter, a technique for implementing a low-delay recognition process will be described in each embodiment with reference to the accompanying drawings. Note that, in the present specification and the drawings, constituent elements having substantially the same functional configuration are denoted by the same reference sign, and redundant description will be omitted.

### First Embodiment

[Outline of Recognition Process by Image Recognition System]

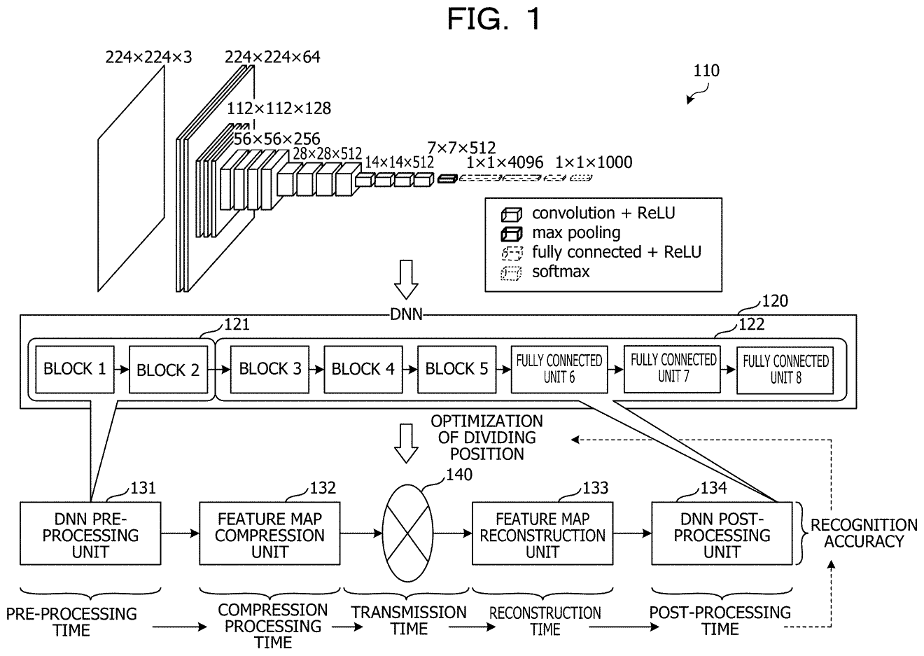

First, an outline of a recognition process by an image recognition system according to a first embodiment will be described. FIG. 1 is a diagram for explaining an outline of the recognition process by the image recognition system. In the image recognition system according to the present embodiment, the processes from an input layer to an intermediate layer of a DNN model are performed by an edge device, and the deep feature maps output from the intermediate layer (hereinafter, simply referred to as feature maps) are transmitted to a cloud device. In addition, in the image recognition system according to the present embodiment, the processes from the intermediate layer to an output layer are performed by a cloud device, based on the transmitted feature maps. Consequently, according to the image recognition system according to the present embodiment, the transmission cost may be reduced, and additionally, a low-delay recognition process for image data may be performed.

In FIG. 1, the reference sign 110 denotes an example of the DNN model and, in the example in FIG. 1, indicates a visual geometry group (VGG) 16. In the case of the VGG16, as indicated by the reference sign 120, the VGG16 may be roughly divided into five blocks, namely, blocks 1 to 5, and three fully connected units, namely, fully connected units 6 to 8.

In the case of the example in FIG. 1, the block 1 is formed by (a convolution layer+a rectified linear unit (ReLU) layer)×2, the block 2 is formed by a max pooling layer×1+(the convolution layer+the ReLU layer)×2, the block 3 is formed by the max pooling layer×1+(the convolution layer+the ReLU layer)×3, the block 4 is formed by the max pooling layer×1+(the convolution layer+the ReLU layer)×3, and the block 5 is formed by the max pooling layer×1+(the convolution layer+the ReLU layer)×3, individually.

In addition, in the case of the example in FIG. 1, the fully connected units 6 to 8 are formed by the max pooling layer+(a fully connected layer+an ReLU)×3+softmax function.

In the present embodiment, the image recognition system is generated by dividing the DNN model indicated by the reference sign 120 at an appropriate dividing position and setting the divided DNN model in the edge device and the cloud device.

Note that, in the image recognition system illustrated in FIG. 1, a DNN pre-processing unit 131 and a feature map compression unit 132 are implemented in the edge device, whereas a feature map reconstruction unit 133 and a DNN post-processing unit 134 are implemented in the cloud device.

Among these, the DNN pre-processing unit 131 is set with blocks located on an input side of the dividing position of the DNN model divided at the determined dividing position. The example in FIG. 1 illustrates how the position between the blocks 2 and 3 is determined as an appropriate dividing position, and the blocks 1 and 2 are set in the DNN pre-processing unit 131. The DNN pre-processing unit 131 performs a pre-process of the DNN model on the input image data and outputs feature maps.

The feature map compression unit 132 performs a compression process on the input feature maps and transmits the compressed feature maps to the feature map reconstruction unit 133 of the cloud device via a network 140.

The feature map reconstruction unit 133 performs a reconstruction process on the compressed feature maps transmitted from the feature map compression unit 132 and inputs the reconstructed feature maps to the DNN post-processing unit 134.

The DNN post-processing unit 134 is set with blocks located on an output side of the dividing position and the fully connected units of the DNN model divided at the determined dividing position. The example in FIG. 1 illustrates how the blocks 3 to 5 and the fully connected units 6 to 8 are set in the DNN post-processing unit 134. The DNN post-processing unit 134 recognizes the image data and outputs the recognition result by performing a post-process of the DNN model based on the reconstructed feature maps.

Here, in the image recognition system according to the present embodiment, in determining the dividing position, the time for the pre-process by the DNN pre-processing unit 131 (pre-processing time), the time for the compression process by the feature map compression unit 132 (compression processing time), the time for transmitting the compressed feature maps to the feature map reconstruction unit 133 from the feature map compression unit 132 (transmission time), the time for the reconstruction process by the feature map reconstruction unit 133 (reconstruction processing time), the time for the post-process by the DNN post-processing unit 134 (post-processing time), and the accuracy of recognition by the DNN post-processing unit 134 (recognition accuracy) are considered to determine the dividing position.

In this manner, while the dividing position has been determined in the past based on the pre-processing time and the post-processing time (which means the amount of computation in each layer), and the transmission time (for example, the amount of data of feature maps), the image recognition system of the present embodiment determines the dividing position, in addition to these, in further consideration of the compression processing time, the reconstruction processing time, and the recognition accuracy.

Consequently, according to the present embodiment, an appropriate dividing position may be determined in line with the configuration of the image recognition system. As a result, according to the image recognition system according to the present embodiment, a low-delay recognition process may be implemented.

[System Configuration of Image Recognition System in Each Phase]

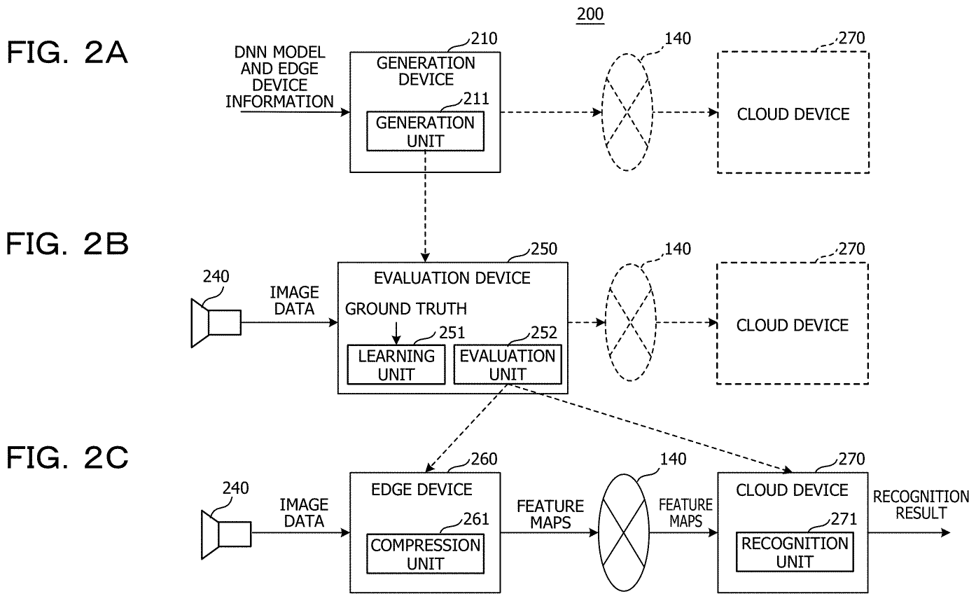

Next, the system configuration of the image recognition system in each phase will be described. FIGS. 2A to 2C are diagrams illustrating an example of the system configuration of the image recognition system in each phase.

Among these, FIG. 2A illustrates an example of the system configuration of an image recognition system 200 in a “generation phase”. The “generation phase” is a phase in which the DNN model is divided at a variety of dividing positions and processing systems including the DNN models with each dividing position are generated.

As illustrated in FIG. 2A, the image recognition system 200 in the generation phase includes a generation device 210. A generation program is installed in the generation device 210, and when the program is executed, the generation device 210 functions as a generation unit 211.

When the DNN model (reference sign 120) is input, the generation unit 211 verifies the divisible position and divides the DNN model at each of the dividing positions of all the variations verified to be divisible. In addition, the generation unit 211 generates a number of processing systems corresponding to the number of variations of the dividing positions by inserting an autoencoder (the feature map compression unit 132 and the feature map reconstruction unit 133) at the dividing positions. Furthermore, the generation unit 211 sets the generated processing systems in an evaluation device 250.

FIG. 2B illustrates an example of the system configuration of the image recognition system 200 in an “evaluation phase”. The “evaluation phase” is a phase in which a processing system having an appropriate dividing position is evaluated from among a plurality of processing systems having different dividing positions from each other.

As illustrated in FIG. 2B, the image recognition system 200 in the evaluation phase includes an imaging device 240 and the evaluation device 250.

The imaging device 240 captures an image at a predetermined frame period and sends image data to the evaluation device 250. Note that the image data includes an object that is a recognition target.

A learning program and an evaluation program are installed in the evaluation device 250, and when the programs are executed, the evaluation device 250 functions as a learning unit 251 and an evaluation unit 252.

The plurality of processing systems generated by the generation unit 211 is set in the learning unit 251, and in the learning unit 251, the image data captured by the imaging device 240 is input to the plurality of processing systems as learning image data. In addition, a ground truth for the recognition target included in the input image data is input to the learning unit 251, and the autoencoder (the feature map compression unit 132 and the feature map reconstruction unit 133) included in each processing system is learned.

The evaluation unit 252 is notified of each of the processing systems including the learned autoencoders that have been learned by the learning unit 251.

The evaluation unit 252 evaluates each processing system notified by the learning unit 251 from the viewpoints of the pre-processing time, the compression processing time, the transmission time, the reconstruction processing time, the post-processing time, and the recognition accuracy. In addition, the evaluation unit 252 selects a processing system having an appropriate dividing position, based on the evaluation result.

Furthermore, the evaluation unit 252 sets an edge device 260 with the blocks located on the input side of the dividing position and the feature map compression unit 132 of the selected processing system. In addition, the evaluation unit 252 sets a cloud device 270 with the blocks located on the output side of the dividing position and the fully connected units, and the feature map reconstruction unit 133 of the selected processing system.

FIG. 2C illustrates an example of the system configuration of the image recognition system 200 in a “recognition phase”. The “recognition phase” is a phase in which a compression, reconstruction, and recognition process is performed on the image data using the processing system having an appropriate dividing position.

As illustrated in FIG. 2C, the image recognition system 200 in the recognition phase includes the imaging device 240, the edge device 260, and the cloud device 270.

Among these, since the imaging device 240 has already been described with reference to FIG. 2B, the description thereof will be omitted here.

A compression program is installed in the edge device 260, and when the program is executed, the edge device 260 functions as a compression unit 261 (including the DNN pre-processing unit 131 and the feature map compression unit 132).

The blocks located on the input side of the dividing position of the processing system having an appropriate dividing position are set in the DNN pre-processing unit 131 of the compression unit 261. Then, the DNN pre-processing unit 131 of the compression unit 261 outputs the feature maps by processing the image data captured by the imaging device 240 up to the dividing position.

In addition, the feature map compression unit 132 of the compression unit 261 compresses the output feature maps and transmits the compressed feature maps to the cloud device 270 via the network 140.

A recognition program is installed in the cloud device 270, and when the program is executed, the cloud device 270 functions as a recognition unit 271 (including the feature map reconstruction unit 133 and the DNN post-processing unit 134).

The feature map reconstruction unit 133 of the recognition unit 271 reconstructs the compressed feature maps transmitted from the compression unit 261.

In addition, the blocks located on the output side of the dividing position and the fully connected units of the processing system having an appropriate dividing position are set in the DNN post-processing unit 134 of the recognition unit 271. The DNN post-processing unit 134 of the recognition unit 271 performs a recognition process on the image data, based on the reconstructed feature maps. Furthermore, the DNN post-processing unit 134 of the recognition unit 271 outputs a result of the recognition process (recognition result).

[Hardware Configuration of Each Device]

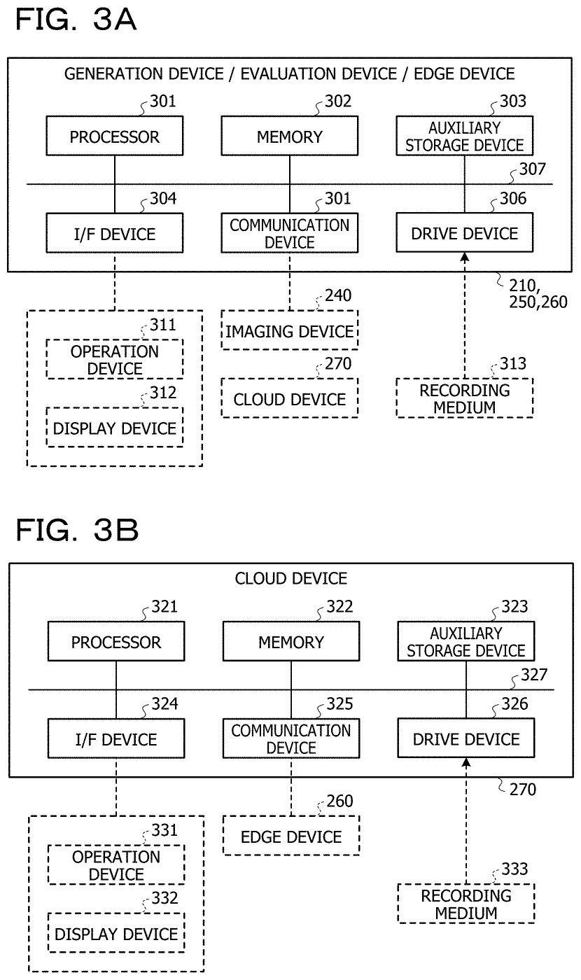

Next, a hardware configuration of each device (the generation device 210, the evaluation device 250, the edge device 260, and the cloud device 270) included in the image recognition system 200 will be described. FIGS. 3A and 3B are diagrams illustrating an example of the hardware configuration of each device included in the image recognition system.

(1) Hardware Configuration of Generation Device, Evaluation Device, and Edge Device

Among these, FIG. 3A is a diagram illustrating an example of the hardware configuration of the generation device 210, the evaluation device 250, and the edge device 260. As illustrated in FIG. 3A, the generation device 210, the evaluation device 250, and the edge device 260 include a processor 301, a memory 302, an auxiliary storage device 303, an interface (I/F) device 304, a communication device 305, and a drive device 306. Note that the respective pieces of hardware included in the generation device 210, the evaluation device 250, and the edge device 260 are interconnected via a bus 307.

The processor 301 includes various computation devices such as a central processing unit (CPU) and a graphics processing unit (GPU). The processor 301 reads various programs (such as the generation program, the learning program, the evaluation program, and the compression program, as an example) into the memory 302 and executes the read programs.

The memory 302 includes a main storage device such as a read only memory (ROM) and a random access memory (RAM). The processor 301 and the memory 302 form a so-called computer. The processor 301 executes various programs read into the memory 302 to cause the computer to implement the above various functions.

The auxiliary storage device 303 stores various programs and various pieces of data used when the various programs are executed by the processor 301.

The I/F device 304 is a connection device connected to external devices (an operation device 311 and a display device 312). The I/F device 304 accepts an operation by the user via the operation device 311. In addition, the I/F device 304 outputs a result of a process and displays the output result via the display device 312.

The communication device 305 is a communication device for communicating with other devices in the image recognition system 200. For example, the communication device 305 communicates with the imaging device 240 and/or the cloud device 270.

The drive device 306 is a device for setting a recording medium 313. The recording medium 313 mentioned here includes a medium that optically, electrically, or magnetically records information, such as a compact disc read only memory (CD-ROM), a flexible disk, or a magneto-optical disk. Alternatively, the recording medium 313 may include a semiconductor memory or the like that electrically records information, such as a ROM or a flash memory.

Note that various programs to be installed in the auxiliary storage device 303 are installed, for example, by setting the distributed recording medium 313 in the drive device 306 and reading the various programs recorded in the recording medium 313 by the drive device 306. Alternatively, the various programs to be installed in the auxiliary storage device 303 may be installed by being downloaded via the communication device 305.

(2) Hardware Configuration of Cloud Device

Next, a hardware configuration of the cloud device 270 will be described. FIG. 3B is a diagram illustrating an example of the hardware configuration of the cloud device. Note that, since the hardware configuration of the cloud device 270 is almost the same as the hardware configuration of the generation device 210, the evaluation device 250, and the edge device 260, the differences will be mainly described here.

For example, a processor 321 reads the recognition program or the like into a memory 322 and executes the read recognition program or the like. The communication device 325 communicates with the edge device 260.

[Functional Configuration of Generation Device]

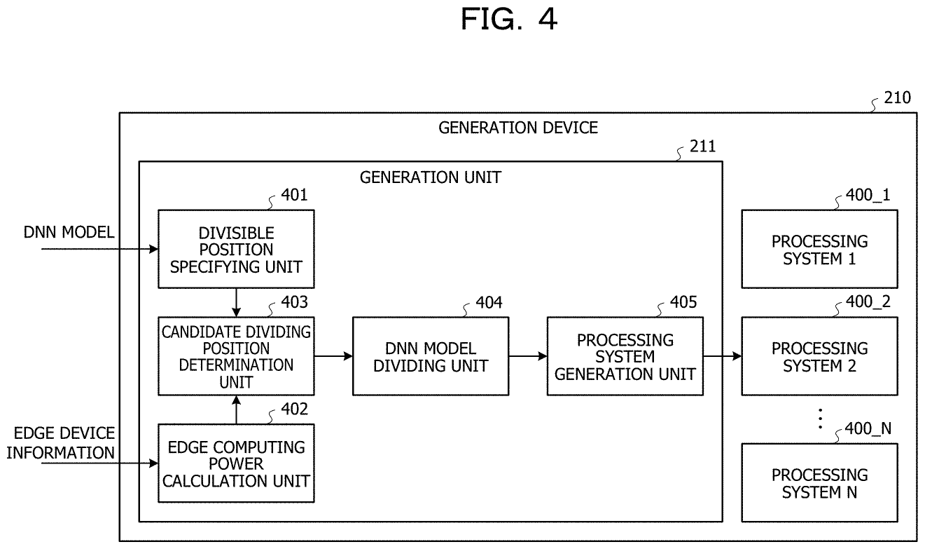

Next, details of a functional configuration of the generation device 210 will be described. FIG. 4 is a diagram illustrating an example of the functional configuration of the generation device. As illustrated in FIG. 4, the generation unit 211 of the generation device 210 includes a divisible position specifying unit 401, an edge computing power calculation unit 402, a candidate dividing position determination unit 403, a DNN model dividing unit 404, and a processing system generation unit 405.

The divisible position specifying unit 401 analyzes the structure of the DNN model in response to the input of a DNN model (for example, the reference sign 120) and specifies a divisible position. In addition, the divisible position specifying unit 401 notifies the candidate dividing position determination unit 403 of information regarding the specified divisible position.

The edge computing power calculation unit 402 acquires information regarding the edge device 260 that functions as the compression unit 261 in the recognition phase and calculates the computing power of the edge device 260. In addition, the edge computing power calculation unit 402 notifies the candidate dividing position determination unit 403 of the calculated computing power.

The candidate dividing position determination unit 403 determines a “candidate dividing position” that may be a dividing position when the DNN model is divided, based on the information regarding the divisible position and the computing power of the edge device 260. In addition, the candidate dividing position determination unit 403 notifies the DNN model dividing unit 404 of the determined candidate dividing position.

The DNN model dividing unit 404 divides the DNN model at each candidate dividing position determined by the candidate dividing position determination unit 403. In addition, the DNN model dividing unit 404 notifies the processing system generation unit 405 of the DNN models divided at each candidate dividing position.

The processing system generation unit 405 generates a plurality of processing systems by inserting an autoencoder (the feature map compression unit 132 and the feature map reconstruction unit 133) at each candidate dividing position in the DNN models divided at each candidate dividing position.

The example in FIG. 4 illustrates how the processing system generation unit 405 generates a processing system 1 (reference sign 400_1), a processing system 2 (reference sign 400_2), . . . and a processing system N (reference sign 400_N), as N processing systems divided at different dividing positions from each other.

[About Dividing Position of DNN Model]

Next, by taking a specific example of the processing system 1 (reference sign 400_1), the processing system 2 (reference sign 400_2), . . . and the processing system N (reference sign 400_N) generated by the processing system generation unit 405, the dividing positions of the DNN model will be described.

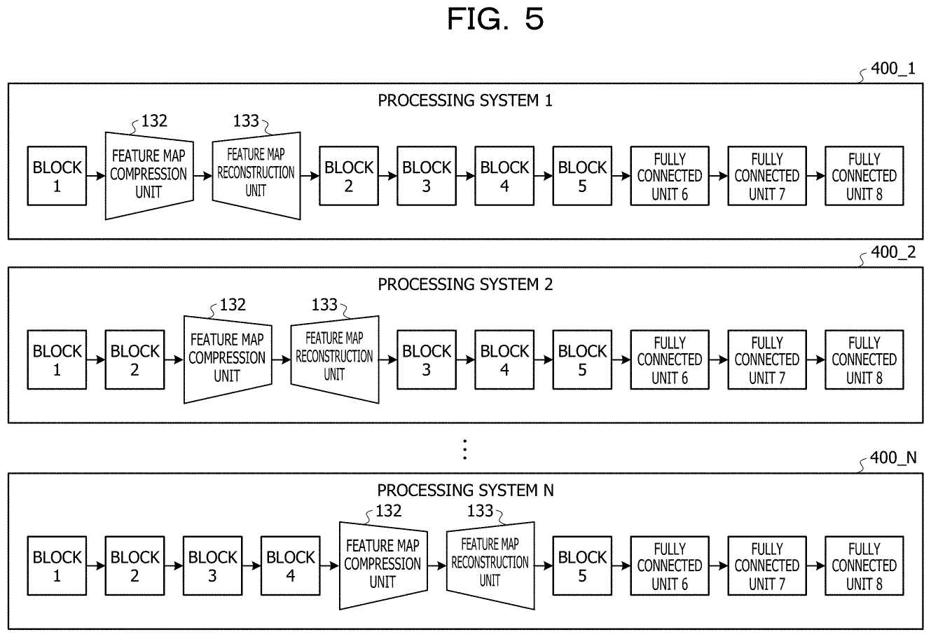

FIG. 5 is a diagram for explaining the dividing positions of the DNN model. In FIG. 5, it is illustrated how the processing system 1 (reference sign 400_1) is obtained by dividing the DNN model between the blocks 1 and 2 and inserting the autoencoder (the feature map compression unit 132 and the feature map reconstruction unit 133) at the dividing position.

In addition, in FIG. 5, it is illustrated how the processing system 2 (reference sign 400_2) is obtained by dividing the DNN model between the blocks 2 and 3 and inserting the autoencoder (the feature map compression unit 132 and the feature map reconstruction unit 133) at the dividing position.

Furthermore, in FIG. 5, it is illustrated how the processing system N (reference sign 400_N) is obtained by dividing the DNN model between the blocks 4 and 5 and inserting the autoencoder (the feature map compression unit 132 and the feature map reconstruction unit 133) at the dividing position.

As described above, according to the generation unit 211 of the generation device 210, processing systems with a variety of dividing positions determined based on the structure of the DNN model and the computing power of the edge device may be generated.

[Functional Configuration of Evaluation Device]

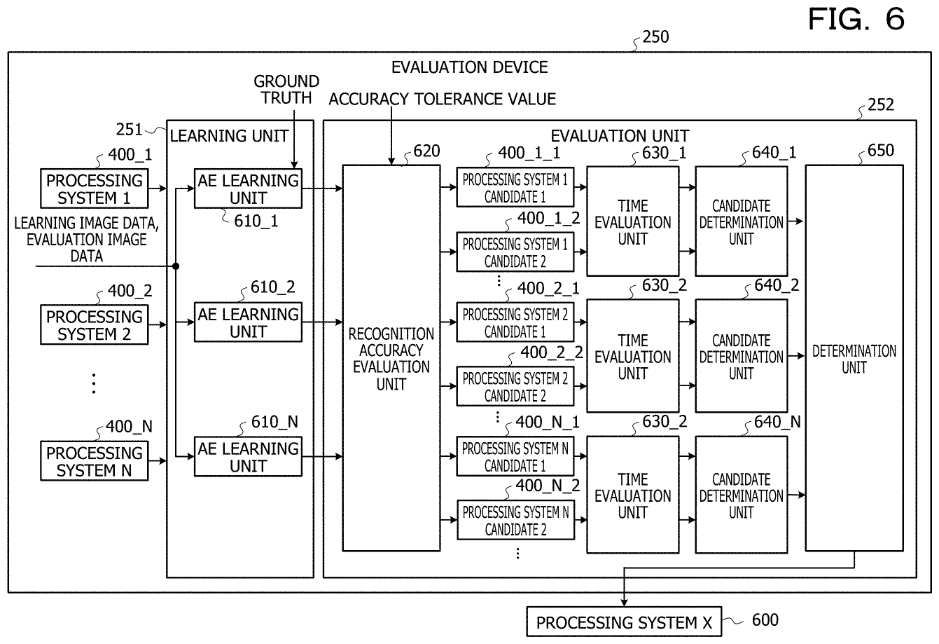

Next, a functional configuration of the evaluation device 250 will be described. FIG. 6 is a diagram illustrating an example of the functional configuration of the evaluation device. As illustrated in FIG. 6, the evaluation device 250 includes the learning unit 251 and the evaluation unit 252.

The learning unit 251 includes a number of AE learning units 610_1 to 610_N according to the number of processing systems generated by the processing system generation unit 405. The AE learning unit 610_1 learns the autoencoder (the feature map compression unit 132 and the feature map reconstruction unit 133) included in the processing system 1 (reference sign 400_1), using the learning image data and the ground truth. In addition, the AE learning unit 610_2 learns the autoencoder (the feature map compression unit 132 and the feature map reconstruction unit 133) included in the processing system 1 (reference sign 400_2), using the learning image data and the ground truth. Hereinafter, similarly, the AE learning unit 610_N learns the autoencoder (the feature map compression unit 132 and the feature map reconstruction unit 133) included in the processing system N (reference sign 400_N), using the learning image data and the ground truth.

Note that the AE learning units 610_1 to 610_N perform learning using costs having different weighting factors when learning their own relevant autoencoders. Therefore, the respective AE learning units 610_1 to 610_N output a number of learning results according to the number of weighting factors.

In addition, the AE learning units 610_1 to 610_N input evaluation image data to the processing system 1 (reference sign 400_1) to the processing system N (reference sign 400_N) in which learning of the autoencoders has been completed, respectively, and execute a compression/reconstruction/recognition process.

Note that, as described above, since the respective AE learning units 610_1 to 610_N output a number of learning results according to the number of weighting factors, each processing system is set with its own relevant learning result, and then the evaluation image data is input and the compression/reconstruction/recognition process is executed.

The evaluation unit 252 includes a recognition accuracy evaluation unit 620, time evaluation units 630_1 to 630_N, candidate determination units 640_1 to 640_N, and a determination unit 650.

The recognition accuracy evaluation unit 620 is preset with an accuracy tolerance value that is a tolerance value for the recognition accuracy, and the recognition accuracy evaluation unit 620 evaluates the recognition accuracy for each learning result, based on the accuracy tolerance value.

For example, the recognition accuracy evaluation unit 620 acquires each recognition result output by setting each learning result in the processing system 1 (reference sign 400_1) and then inputting the evaluation image data and executing the compression/reconstruction/recognition process. In addition, the recognition accuracy evaluation unit 620 identifies a learning result corresponding to the recognition result equal to or higher than the accuracy tolerance value, by comparing the preset accuracy tolerance value and each recognition result.

The example in FIG. 6 illustrates how a processing system 1 candidate 1 (reference sign 400_1_1), a processing system 1 candidate 2 (reference sign 400_1_2), . . . are identified as learning results corresponding to recognition results equal to or higher than the accuracy tolerance value.

Similarly, the recognition accuracy evaluation unit 620 acquires each recognition result output by setting each learning result in the processing system 2 (reference sign 400_2) and then inputting the evaluation image data and executing the compression/reconstruction/recognition process. In addition, the recognition accuracy evaluation unit 620 identifies a learning result corresponding to the recognition result equal to or higher than the accuracy tolerance value, by comparing the preset accuracy tolerance value and each recognition result.

The example in FIG. 6 illustrates how a processing system 2 candidate 1 (reference sign 400_2_1), a processing system 2 candidate 2 (reference sign 400_2_2), . . . are identified as learning results corresponding to recognition results equal to or higher than the accuracy tolerance value.

Similarly, the recognition accuracy evaluation unit 620 acquires each recognition result output by setting each learning result in the processing system N (reference sign 400_N) and then inputting the evaluation image data and executing the compression/reconstruction/recognition process. In addition, the recognition accuracy evaluation unit 620 identifies a learning result corresponding to the recognition result equal to or higher than the accuracy tolerance value, by comparing the preset accuracy tolerance value and each recognition result.

The example in FIG. 6 illustrates how a processing system N candidate 1 (reference sign 400_N_1), a processing system N candidate 2 (reference sign 400_N_2), . . . are identified as learning results corresponding to recognition results equal to or higher than the accuracy tolerance value.

The time evaluation unit 630_1 acquires the processing time of each of the processing system 1 candidate 1, the processing system 1 candidate 2, . . . identified by the recognition accuracy evaluation unit 620 when executing the compression/reconstruction/recognition process using the evaluation image data, and calculates the total value.

For example, the time evaluation unit 630_1 acquires the pre-processing time, the compression processing time, the transmission time, the reconstruction processing time, and the post-processing time of the processing system 1 candidate 1 when executing the compression/reconstruction/recognition process on the evaluation image data, and calculates the total value. In addition, the time evaluation unit 630_1 acquires the pre-processing time, the compression processing time, the transmission time, the reconstruction processing time, and the post-processing time of the processing system 1 candidate 2 when executing the compression/reconstruction/recognition process on the evaluation image data, and calculates the total value. Hereinafter, similarly, the time evaluation unit 630_1 calculates a number of total values according to the number of processing system candidates identified by the recognition accuracy evaluation unit 620 with respect to the processing system 1.

The time evaluation unit 630_2 acquires the processing time of each of the processing system 2 candidate 1, the processing system 2 candidate 2, . . . identified by the recognition accuracy evaluation unit 620 when executing the compression/reconstruction/recognition process using the evaluation image data, and calculates the total value.

For example, the time evaluation unit 630_2 acquires the pre-processing time, the compression processing time, the transmission time, the reconstruction processing time, and the post-processing time of the processing system 2 candidate 1 when executing the compression/reconstruction/recognition process on the evaluation image data, and calculates the total value. In addition, the time evaluation unit 630_2 acquires the pre-processing time, the compression processing time, the transmission time, the reconstruction processing time, and the post-processing time of the processing system 2 candidate 2 when executing the compression/reconstruction/recognition process on the evaluation image data, and calculates the total value. Hereinafter, similarly, the time evaluation unit 630_2 calculates a number of total values corresponding to the number of processing system candidates identified by the recognition accuracy evaluation unit 620 with respect to the processing system 2.

Similarly, the time evaluation unit 630_N acquires the processing time of each of the processing system N candidate 1, the processing system N candidate 2, . . . identified by the recognition accuracy evaluation unit 620 when executing the compression/reconstruction/recognition process using the evaluation image data, and calculates the total value.

For example, the time evaluation unit 630_N acquires the pre-processing time, the compression processing time, the transmission time, the reconstruction processing time, and the post-processing time of the processing system N candidate 1 when executing the compression/reconstruction/recognition process on the evaluation image data, and calculates the total value. In addition, the time evaluation unit 630_N acquires the pre-processing time, the compression processing time, the transmission time, the reconstruction processing time, and the post-processing time of the processing system N candidate 2 when executing the compression/reconstruction/recognition process on the evaluation image data, and calculates the total value. Hereinafter, similarly, the time evaluation unit 630_N calculates a number of total values according to the number of processing system candidates identified by the recognition accuracy evaluation unit 620 with respect to the processing system N.

The candidate determination unit 640_1 extracts a minimum total value from among the total values calculated by the time evaluation unit 630_1 and identifies the processing system candidate corresponding to the extracted total value. In addition, the candidate determination unit 640_1 notifies the determination unit 650 of the identified processing system candidate as a processing system 1 candidate x.

The candidate determination unit 640_2 extracts a minimum total value from among the total values calculated by the time evaluation unit 630_2 and identifies the processing system candidate corresponding to the extracted total value. In addition, the candidate determination unit 640_2 notifies the determination unit 650 of the identified processing system candidate as a processing system 2 candidate x.

Hereinafter, similarly, the candidate determination unit 640_N extracts a minimum total value from among the total values calculated by the time evaluation unit 630_N and identifies the processing system candidate corresponding to the extracted total value. In addition, the candidate determination unit 640_N notifies the determination unit 650 of the identified processing system candidate as a processing system N candidate x.

The determination unit 650 determines a processing system having the best combination of the recognition accuracy and the total value of the processing time, from among the processing system 1 candidate x to the processing system N candidate x notified by the candidate determination units 640_1 to 640_N, respectively. The example in FIG. 6 illustrates how a processing system X (reference sign 600) is determined as the best processing system.

[Details of Functional Configuration of AE Learning Unit]

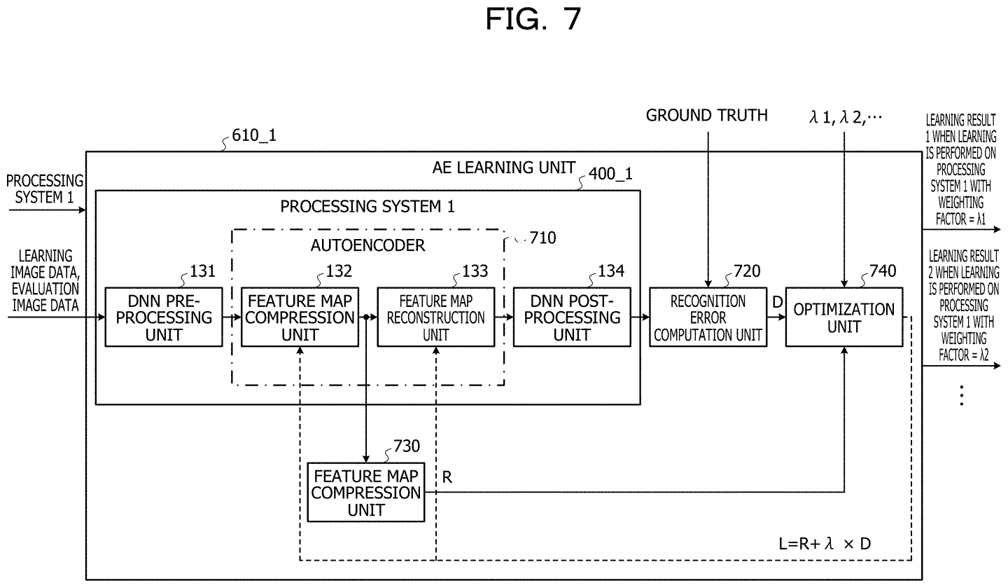

Next, details of a functional configuration of the AE learning unit (here, the AE learning unit 610_1) will be described. FIG. 7 is a first diagram illustrating details of a functional configuration of the AE learning unit. As illustrated in FIG. 7, the AE learning unit 610_1 is set with the processing system 1 (reference sign 400_1).

The processing system 1 (reference sign 400_1) includes the DNN pre-processing unit 131, an autoencoder 710 (the feature map compression unit 132 and the feature map reconstruction unit 133), and the DNN post-processing unit 134. Note that, since each unit of the processing system 1 (reference sign 400_1) has already been described, the description thereof will be omitted here.

In addition, the AE learning unit 610_1 includes a recognition error computation unit 720, an information amount computation unit 730, and an optimization unit 740.

The recognition error computation unit 720 checks output data output from the processing system 1 (reference sign 400_1) by inputting the learning image data to the processing system 1 (reference sign 400_1), against the ground truth, and computes an error (D). In addition, the recognition error computation unit 720 notifies the optimization unit 740 of the computed error (D).

The information amount computation unit 730 calculates the probability distribution of the feature maps compressed by the feature map compression unit 132 and computes information entropy (R) of the probability distribution. In addition, the information amount computation unit 730 notifies the optimization unit 740 of the computed information entropy (R).

Note that the method of computing the information entropy by the information amount computation unit 730 is optional, and for example, a Gaussian Mixture Model (GMM) may be used as a probability model. The optimization unit 740 calculates a cost (L) using the error (D) notified by the recognition error computation unit 720 and the information entropy (R) notified by the information amount computation unit 730, based on following formula (1).

Cost (L)=R+λ×D Formula 1

Note that, in above formula 1, λ denotes a weighting factor.

The AE learning unit 610_1 updates a model parameter of the autoencoder 710 (the feature map compression unit 132 and the feature map reconstruction unit 133) such that the cost (L) calculated by the optimization unit 740 is minimized.

Note that the optimization unit 740 calculates the cost (L) using different weighting factors λ when learning the autoencoder 710. Therefore, the AE learning unit 610_1 outputs a number of learning results according to the number of weighting factors λ.

The example in FIG. 7 illustrates how a learning result 1 (model parameter 1) is output by performing learning of the processing system 1 (reference sign 400_1) using the learning image data while calculating the cost (L) with “λ1” set as the weighting factor λ.

In addition, the example in FIG. 7 illustrates how a learning result 2 (model parameter 2) is output by performing learning of the processing system 1 (reference sign 400_1) using the learning image data while calculating the cost (L) with “λ2” set as the weighting factor A. Note that the learning result 1 (model parameter 1), the learning result 2 (model parameter 2), . . . output from the AE learning unit 610_1 are each set in the autoencoder 710 when the evaluation image data is input. This will cause the processing system 1 (reference sign 400_1) to output recognition results according to each weighting factor when the evaluation image data is input.

[Details of Functional Configuration of Time Evaluation Unit]

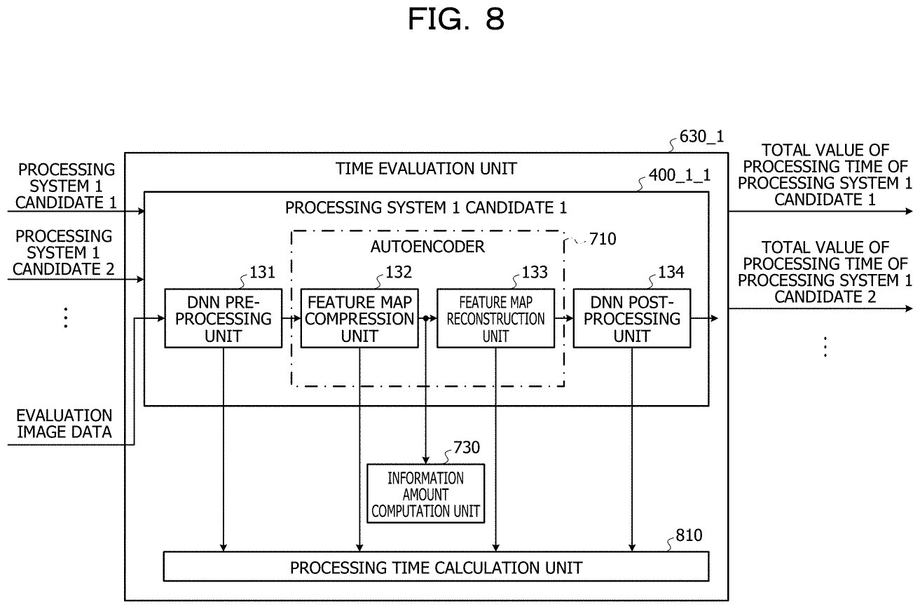

Next, details of a functional configuration of the time evaluation unit (here, the time evaluation unit 630_1) will be described. FIG. 8 is a diagram illustrating details of a functional configuration of the time evaluation unit. As illustrated in FIG. 8, the time evaluation unit 630_1 is sequentially set with the processing system 1 candidate 1 (reference sign 400_1_1), the processing system 1 candidate 2 (reference sign 400_1_2), . . . .

The processing system 1 candidate 1 (reference sign 400_1_1) includes the DNN pre-processing unit 131, the autoencoder 710 (the feature map compression unit 132 and the feature map reconstruction unit 133), and the DNN post-processing unit 134. Note that, in the processing system 1 candidate 1 (reference sign 400_1_1), the autoencoder 710 is set with the learning result (model parameter) when learning is performed in a state in which “λ1” is set as the weighting factor λ.

In addition, as illustrated in FIG. 8, the time evaluation unit 630_1 includes the information amount computation unit 730 and a processing time calculation unit 810.

The information amount computation unit 730 calculates the probability distribution of the feature maps compressed by the feature map compression unit 132 when the evaluation image data is input to, for example, the processing system 1 candidate 1 (reference sign 400_1_1), and computes the information entropy (R) of the probability distribution.

The processing time calculation unit 810 acquires the pre-processing time, the compression processing time, the reconstruction processing time, and the post-processing time when the evaluation image data is input to, for example, the processing system 1 candidate 1 (reference sign 400_1_1). In addition, the processing time calculation unit 810 calculates the transmission time based on the information entropy (R) computed by the information amount computation unit 730.

Furthermore, the processing time calculation unit 810 calculates the total value of the pre-processing time, the compression processing time, the reconstruction processing time, the post-processing time, and the transmission time. The example in FIG. 8 illustrates how the total value calculated when the processing system 1 candidate 1 (reference sign 400_1_1) is set is output. In addition, the example in FIG. 8 illustrates how the total value calculated when the processing system 1 candidate 2 (reference sign 400_1_2) is set is output.

Hereinafter, the time evaluation unit 630_1 outputs a number of total values according to the number of set processing system candidates.

[Flow of Generation Process by Generation Device]

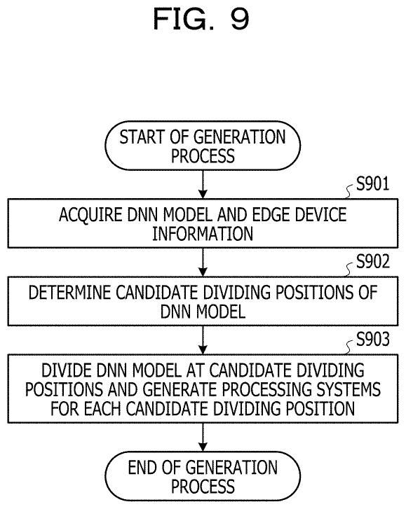

Next, a flow of a generation process by the generation device 210 will be described. FIG. 9 is a flowchart illustrating a flow of the generation process by the generation device.

In operation S901, the generation device 210 acquires the DNN model and edge device information.

In operation S902, the generation device 210 determines the candidate dividing positions based on the structure of the DNN model and the edge device information that have been acquired.

In operation S903, the generation device 210 generates processing systems by dividing the DNN model at the determined candidate dividing positions and inserting the autoencoder at each candidate dividing position.

[Flow of Evaluation Process by Evaluation Device]

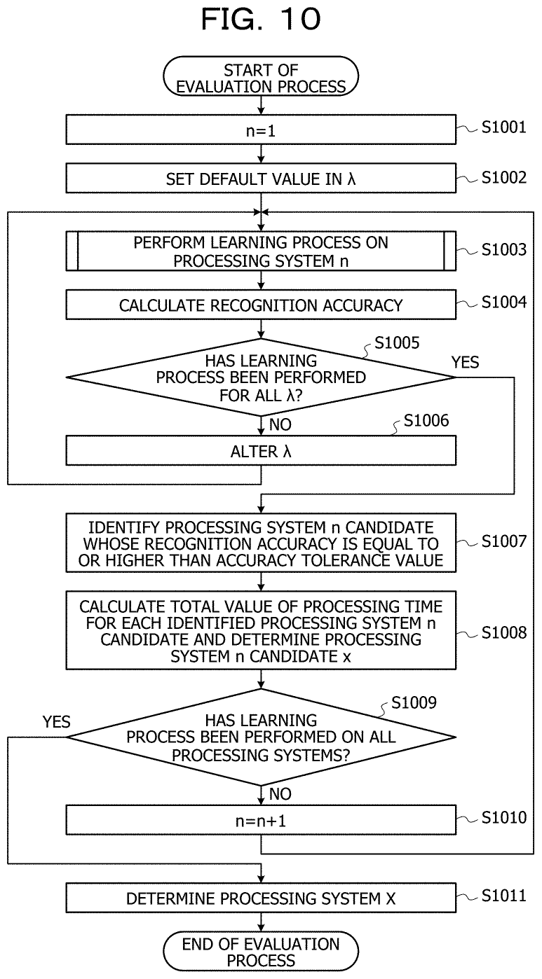

Next, a flow of an evaluation process by the evaluation device 250 will be described. FIG. 10 is a first flowchart illustrating a flow of the evaluation process by the evaluation device.

In operation S1001, the evaluation device 250 inputs “1” to a counter n that counts the generated processing systems.

In operation S1002, the evaluation device 250 sets a default value in the weighting factor λ.

In operation S1003, the evaluation device 250 performs a learning process on the processing system n under the current weighting factor λ. Note that details of the learning process for the processing system n will be described later.

In operation S1004, the evaluation device 250 inputs the evaluation image data after setting the learning result output by performing the learning process under the current weighting factor λ in the processing system n, and calculates the recognition accuracy.

In operation S1005, the evaluation device 250 verifies whether or not the learning process has been performed under all the weighting factors λ. When it is verified in operation S1005 that there is a weighting factor λ with which the learning process has not been performed (when it is verified as NO in operation S1005), the process proceeds to operation S1006.

In operation S1006, the evaluation device 250 alters the weighting factor λ and then returns to operation S1003.

On the other hand, when it is verified in operation S1005 that the learning process has been performed under all the weighting factors λ (when it is verified as YES in operation S1005), the process proceeds to operation S1007.

In operation S1007, the evaluation device 250 identifies a processing system n candidate whose recognition accuracy is equal to or higher than the accuracy tolerance value.

In operation S1008, the evaluation device 250 calculates the total value of the processing time for each processing system n candidate and determines the processing system n candidate x.

In operation S1009, the evaluation device 250 verifies whether or not the learning process has been performed on all the generated processing systems.

When it is verified in operation S1009 that there is a processing system on which the learning process has not been performed (when it is verified as NO in operation S1009), the process proceeds to operation S1010.

In operation S1010, the evaluation device 250 increments the counter n and returns to operation S1003.

On the other hand, when it is verified in operation S1009 that the learning process has been performed on all the generated processing systems (when it is verified as YES in operation S1009), the process proceeds to operation S1011.

In operation S1011, the evaluation device 250 determines the best processing system X based on the combination of the recognition accuracy and the total value of the processing time.

[Details of Learning Process for Processing System n]

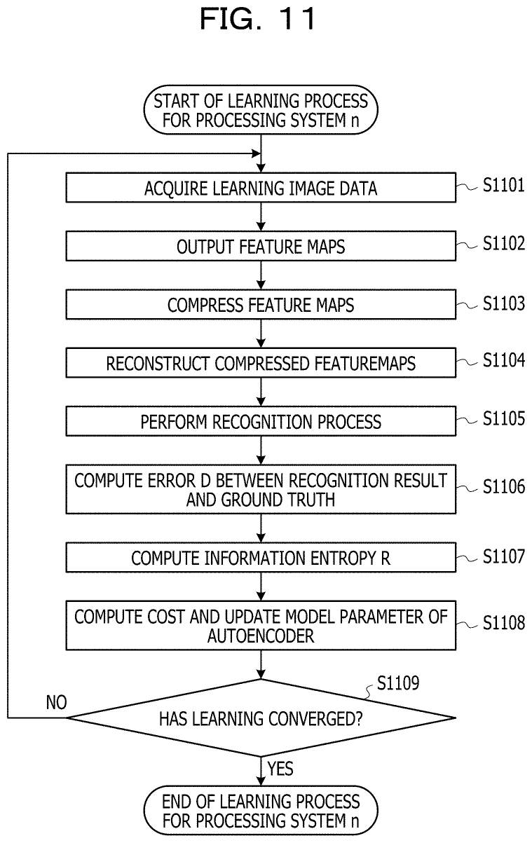

Next, details of the learning process (operation S1003 in FIG. 10) for the processing system n will be described. FIG. 11 is a first flowchart illustrating a detailed flow of the learning process for the processing system n.

In operation S1101, the learning unit 251 of the evaluation device 250 acquires the learning image data.

In operation S1102, in the learning unit 251 of the evaluation device 250, the DNN pre-processing unit 131 outputs feature maps based on the learning image data.

In operation S1103, in the learning unit 251 of the evaluation device 250, the feature map compression unit 132 compresses the output feature maps.

In operation S1104, in the learning unit 251 of the evaluation device 250, the feature map reconstruction unit 133 reconstructs the compressed feature maps.

In operation S1105, in the learning unit 251 of the evaluation device 250, the DNN post-processing unit 134 performs the recognition process based on the reconstructed feature maps.

In operation S1106, the learning unit 251 of the evaluation device 250 computes the error (D) between the recognition result and the ground truth.

In operation S1107, the learning unit 251 of the evaluation device 250 computes the information entropy (R) when the feature map compression unit 132 compressed the feature maps.

In operation S1108, the learning unit 251 of the evaluation device 250 computes the cost under the current weighting factor λ and updates the model parameter of the autoencoder 710.

In operation S1109, the learning unit 251 of the evaluation device 250 verifies whether or not the learning has converged. When it is verified in operation S1009 that the learning has not converged (when it is verified as NO in operation S1109), the process returns to operation S1101.

On the other hand, when it is verified in operation S1109 that the learning has converged (when it is verified as YES in operation S1109), the learning process for the processing system n is ended.

[Functional Configuration of Edge Device and Cloud Device]

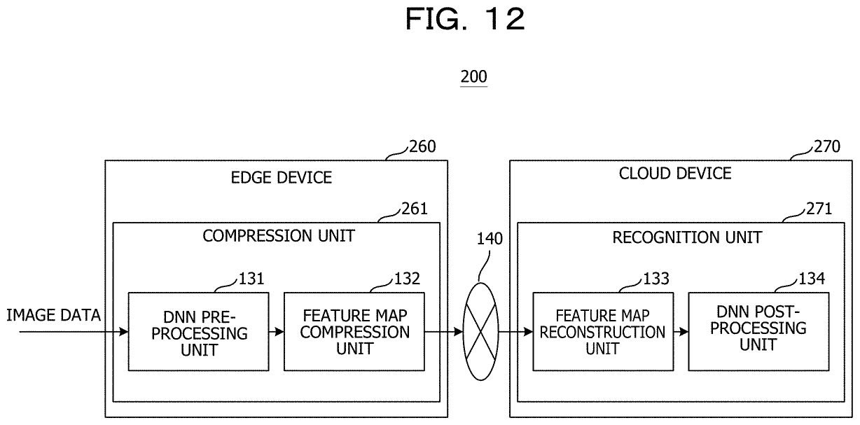

Next, the functional configuration of the edge device 260 and the cloud device 270 of the image recognition system 200 in the “recognition phase” will be described. FIG. 12 is a first diagram illustrating an example of the functional configuration of the edge device and the cloud device.

As illustrated in FIG. 12, in the recognition phase, the compression unit 261 of the edge device 260 includes the DNN pre-processing unit 131 and the feature map compression unit 132.

The DNN pre-processing unit 131 included in the compression unit 261 of the edge device 260 is set with the blocks located on the input side of the determined dividing position of the best processing system (for example, the processing system X) determined by the evaluation device 250.

The feature map compression unit 132 included in the compression unit 261 of the edge device 260 is set with the feature map compression unit 132 of the autoencoder 710 of the best processing system (for example, the processing system X) determined by the evaluation device 250.

In addition, as illustrated in FIG. 12, in the recognition phase, the recognition unit 271 of the cloud device 270 includes the feature map reconstruction unit 133 and the DNN post-processing unit 134.

The feature map reconstruction unit 133 included in the recognition unit 271 of the cloud device 270 is set with the feature map reconstruction unit 133 of the autoencoder 710 of the best processing system (for example, the processing system X) determined by the evaluation device 250.

The DNN post-processing unit 134 included in the recognition unit 271 of the cloud device 270 is set with the blocks located on the output side of the determined dividing position and the fully connected units of the best processing system (for example, the processing system X) determined by the evaluation device 250.

[Flow of Compression/Reconstruction/Recognition Process by Edge Device and Cloud Device]

Next, a flow of the compression/reconstruction/recognition process by the edge device 260 and the cloud device 270 of the image recognition system 200 in the “recognition phase” will be described.

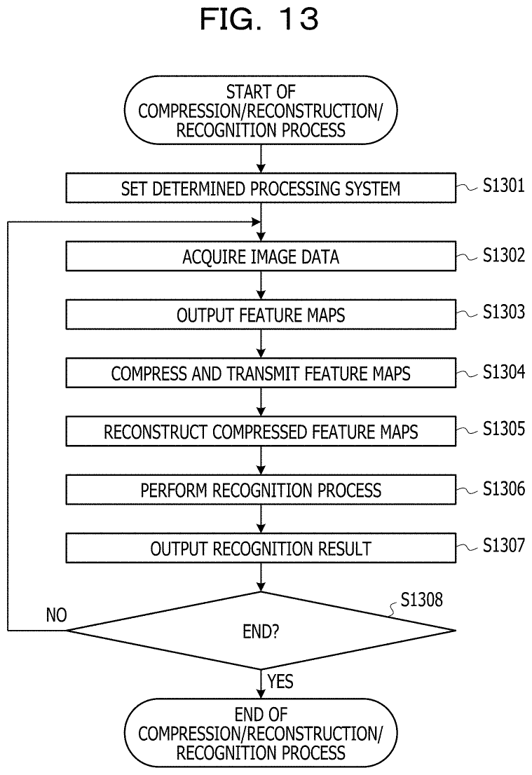

FIG. 13 is a first flowchart illustrating a flow of the compression/reconstruction/recognition process by the edge device and the cloud device.

In operation S1301, the evaluation device 250 sets the best processing system in the edge device 260 and the cloud device 270.

In operation S1302, the edge device 260 acquires image data from the imaging device 240.

In operation S1303, in the compression unit 261 of the edge device 260, the DNN pre-processing unit 131 outputs the feature maps based on the image data.

In operation S1304, in the compression unit 261 of the edge device 260, the feature map compression unit 132 compresses the output feature maps and transmits the compressed feature maps to the cloud device 270.

In operation S1305, in the recognition unit 271 of the cloud device 270, the feature map reconstruction unit 133 reconstructs the compressed feature maps.

In operation S1306, in the recognition unit 271 of the cloud device 270, the DNN post-processing unit 134 performs the recognition process for the image data, based on the reconstructed feature maps.

In operation S1307, the recognition unit 271 of the cloud device 270 outputs the recognition result.

In operation S1308, the compression unit 261 of the edge device 260 verifies whether or not the process is to be ended. When it is verified in operation S1308 that the process is to be continued (when it is verified as NO in operation S1308), the process returns to operation S1302.

On the other hand, when it is verified in operation S1308 that the process is to be ended (when it is verified as YES in operation S1308), the compression/reconstruction/recognition process is ended.

[Application Example of Image Recognition System]

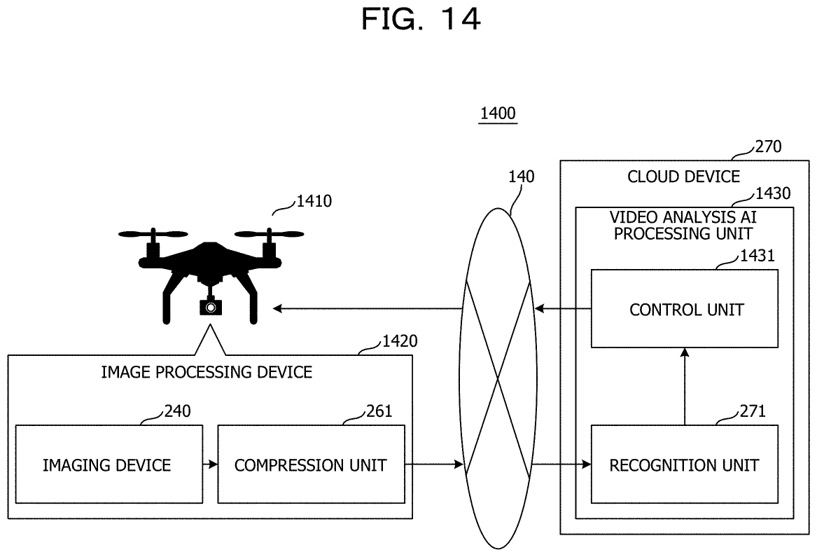

Next, an application example of the image recognition system in the “recognition phase” will be described. FIG. 14 is a diagram illustrating an application example of the image recognition system.

The example in FIG. 14 illustrates a case where the image recognition system 200 is applied to a remote system including a drone 1410 and the cloud device 270 connected to the drone 1410 such that communication is allowed.

As illustrated in FIG. 14, the remote system 1400 includes the drone 1410 and the cloud device 270. In the remote system 1400, an image processing device 1420 of the drone 1410 and the cloud device 270 are connected via the network 140 such that communication is allowed.

The image processing device 1420 of the drone 1410 includes the imaging device 240 and the compression unit 261. Note that, since the details of each of the imaging device 240 and the compression unit 261 have already been described, the description thereof will be omitted here.

The cloud device 270 functions as a video analysis artificial intelligence (AI) processing unit 1430, and the video analysis AI processing unit 1430 includes the recognition unit 271 and a control unit 1431. Among these, since the details of the recognition unit 271 have already been described, the description thereof will be omitted here.

The control unit 1431 outputs a control command for controlling the flight of the drone 1410, based on the recognition result output by the recognition unit 271. Note that the control command output by the control unit 1431 is sent to the drone 1410 via the network 140. This allows the drone 1410 to control flight based on the sent control command.

As is clear from the above description, the image recognition system 200 according to the first embodiment includes the DNN pre-processing unit that performs the processes up to the determined dividing position in the DNN model by taking image data as input, and outputs the feature maps. In addition, the image recognition system 200 according to the first embodiment includes the feature map compression unit that compresses the output feature maps and transmits the compressed feature maps, and the feature map reconstruction unit that receives and reconstructs the compressed feature maps. In addition, the image recognition system 200 according to the first embodiment includes the DNN post-processing unit that performs the processes after the dividing position in the DNN model by taking the reconstructed feature maps as input, and outputs the recognition result. Furthermore, in the image recognition system 200 according to the first embodiment, the above dividing position is determined by using the processing time by each unit and the accuracy of the recognition result.

Consequently, according to the first embodiment, an appropriate dividing position may be determined in line with the configuration of the image recognition system. As a result, according to the image recognition system according to the first embodiment, a low-delay recognition process may be implemented.

### Second Embodiment

In the above first embodiment, the case where the divisible position specifying unit 401 analyzes the structure of the VGG16 has been described, but the target for the divisible position specifying unit 401 to analyze the structure is not limited to the VGG16 and may be other DNN models. In a second embodiment, as an example, a case where a divisible position specifying unit 401 analyzes the structure of a You Only Look Once version 3 (YOLOv3) will be described.

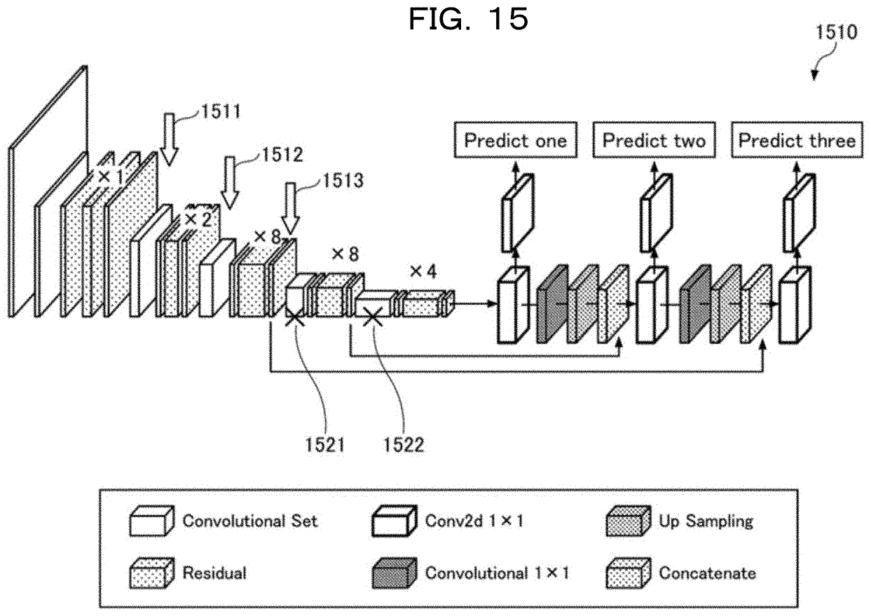

FIG. 15 is a diagram illustrating a specific example of a process of the divisible position specifying unit. In FIG. 15, the reference sign 1510 indicates the YOLOv3.

As indicated by the reference sign 1510, the YOLOv3 is constituted by a large number of layers. Therefore, if the divisible position specifying unit 401 specifies all the positions between the layers as divisible positions, the number of processing systems generated by a processing system generation unit 405 increases.

Meanwhile, as indicated by the reference sign 1510, the YOLO v3 has a structure in which the size of the feature maps changes for every plurality of layers. Here, for example, even if two positions between layers that do not cause changes in the size of the feature maps are each specified as a divisible position, the respective corresponding processing systems are both supposed to be divided at a position that gives the same size of the feature maps from each other. For example, the respective processing systems produce no large difference in the recognition accuracy and the total value of the processing time (the total value of the pre-processing time, the compression processing time, the transmission time, the reconstruction processing time, and the post-processing time).

Thus, from the viewpoint of improving the efficiency of the evaluation process, the divisible position specifying unit 401 in the second embodiment specifies the position between layers that causes a change in the size of the feature maps, as a divisible position. In FIG. 15, the arrows 1511 to 1513 indicate the positions specified as divisible positions by the divisible position specifying unit 401 in the second embodiment.

In addition, as indicated by the reference sign 1510, the YOL0v3 includes a layer at which the process branches. Here, in the case of dividing at layers after a layer at which the process branches, the feature maps output in a layer before the layer have to be transmitted to a cloud device 270 via a network 140.

Thus, from the viewpoint of shortening the transmission time, the divisible position specifying unit 401 in the second embodiment excludes a layer located after the layer at which the process branches, from the divisible position. In FIG. 15, × marks 1521 and 1522 indicate layers excluded from the divisible positions by the divisible position specifying unit 401 in the second embodiment.

As described above, according to the divisible position specifying unit 401 in the second embodiment, the evaluation process in the evaluation phase may be made more efficient, and additionally, the transmission time in the recognition phase may be shortened.

### Third Embodiment

In the above first embodiment, a processing system having an appropriate dividing position is determined by extracting single processing system candidates at each dividing position by selecting a processing system candidate that minimizes the total value of the processing time from among the processing system candidates whose recognition accuracy is equal to or higher than the accuracy tolerance value, and determining a processing system having the best combination of the recognition accuracy and the total value of the processing time from among the single processing system candidates extracted at each dividing position.

In contrast to this, in a third embodiment, a processing system having an appropriate dividing position is determined by generating processing systems that maximize the recognition accuracy at each dividing position, and determining a processing system having the best combination of the recognition accuracy and the total value of the processing time from among single processing systems generated at each dividing position.

[Details of Functional Configuration of AE Learning Unit]

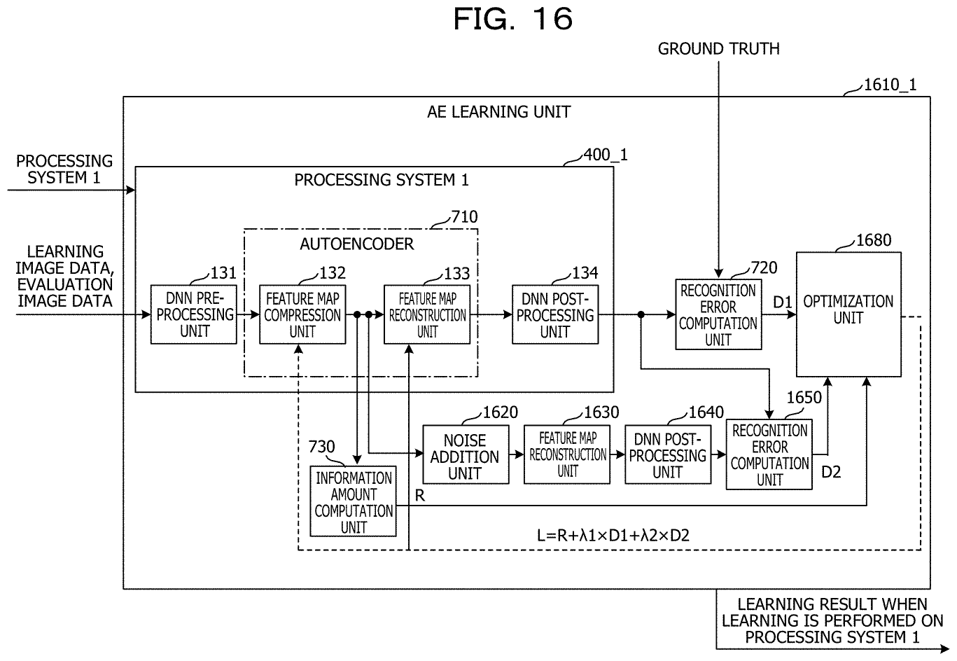

First, details of a functional configuration of an AE learning unit in the third embodiment will be described. FIG. 16 is a second diagram illustrating details of a functional configuration of the AE learning unit. In the case of the AE learning unit 1610_1 in FIG. 16, the differences from the AE learning unit 610_1 illustrated in FIG. 7 are that a noise addition unit 1620, a feature map reconstruction unit 1630, a DNN post-processing unit 1640, and a recognition error computation unit 1650 are included, and the function of an optimization unit 1680 is different from the function of the optimization unit 740 illustrated in FIG. 7.

The noise addition unit 1620 adds noise to the feature maps compressed by a feature map compression unit 132 and generates compressed feature maps with noise.

The feature map reconstruction unit 1630 reconstructs the compressed feature maps with noise and generates the feature maps with noise.

The DNN post-processing unit 1640 performs the recognition process based on the feature maps with noise and outputs the recognition result.

The recognition error computation unit 1650 checks the recognition result output by the DNN post-processing unit 1640 against the recognition result output by a DNN post-processing unit 134, and computes an error (D2).

The optimization unit 1680 calculates the cost (L) using the error (D1) computed by a recognition error computation unit 720, the error (D2) computed by the recognition error computation unit 1650, and the information entropy (R) computed by an information amount computation unit 730, based on following formula (2).

Cost (L)=R+λ1×D1+A2×D2 Formula 2

Note that, in above formula 2, Al and A2 denote fixed weighting factors.

The AE learning unit 1610_1 updates the model parameter of the autoencoder 710 such that the cost (L) calculated by the optimization unit 1680 is minimized. Consequently, in the AE learning unit 1610_1, the recognition result may be brought closer to the ground truth (the recognition accuracy may be improved) because the model parameter is updated such that the error (D1) becomes smaller. The feature maps may be scaled, and an important feature map for precisely recognizing the image data may be narrowed down (the transmission time may be shortened) because the model parameter is updated such that the error (D2) becomes smaller. The amount of data of feature maps may be reduced (the transmission time may be shortened) because the model parameter is updated such that the information entropy (R) becomes smaller.

[Flow of Evaluation Process by Evaluation Device]

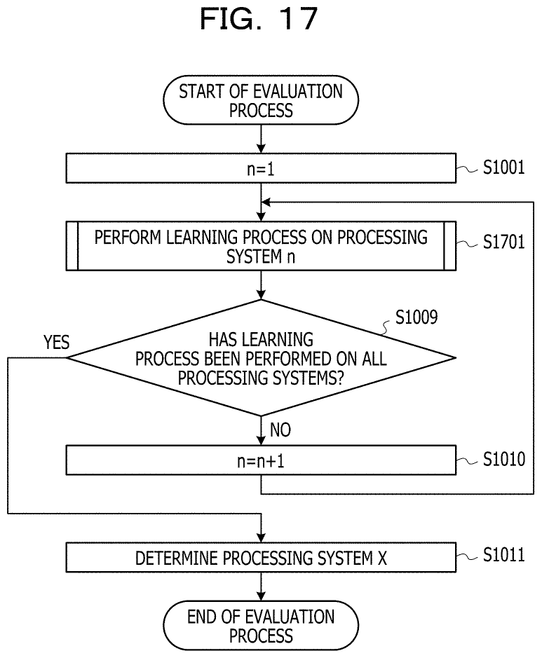

Next, a flow of an evaluation process by an evaluation device when the AE learning unit in the third embodiment is included will be described. FIG. 17 is a second flowchart illustrating a flow of the evaluation process by the evaluation device. In the case of the second flowchart in FIG. 17, the difference from the first flowchart described with reference to FIG. 10 in the above first embodiment is that the processes in operations S1002 to S1008 are not included, and the process in operation S1701 is included.

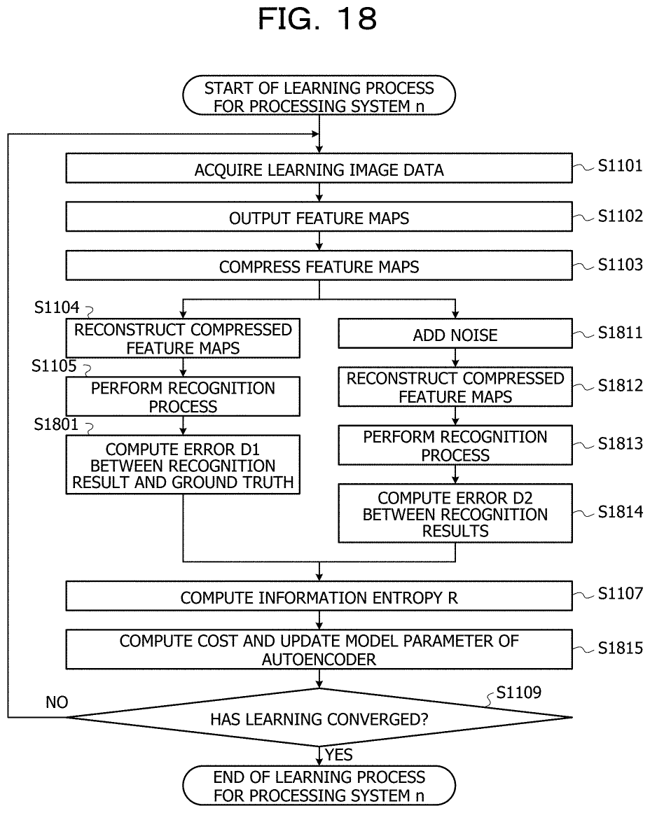

In operation S1701, the evaluation device 250 performs a learning process on the processing system n. Note that details of the learning process for the processing system n will be described with reference to FIG. 18.

FIG. 18 is a second flowchart illustrating a detailed flow of the learning process for the processing system n. The differences from the first flowchart described with reference to FIG. 11 in the above first embodiment are the process in operation S1801 is included instead of operation S1106, the processes in operations S1811 to S1814 are included, and the process in operation S1815 is different from the process in operation S1108 in FIG. 11.

In operation S1801, the recognition error computation unit 720 checks the recognition result output from the DNN post-processing unit 134 against the ground truth and computes the error (D1).

In operation S1811, the noise addition unit 1620 generates compressed feature maps with noise by adding noise to the feature maps compressed by the feature map compression unit 132.

In operation S1812, the feature map reconstruction unit 1630 reconstructs the compressed feature maps with noise and generates the feature maps with noise.

In operation S1813, the DNN post-processing unit 1640 performs the recognition process based on the feature maps with noise and outputs the recognition result.

In operation S1814, the recognition error computation unit 1650 checks the recognition result output from the DNN post-processing unit 1640 against the recognition result output from the DNN post-processing unit 134 and computes the error (D2).

In operation S1815, the optimization unit 1680 calculates the cost (L) based on the error (D1), the error (D2), and the information entropy (R). In addition, the AE learning unit 1610_1 updates the model parameter of the autoencoder 710 based on the calculated cost.

As described above, according to the AE learning unit 1610_1 in the third embodiment, the evaluation process in the evaluation phase may be made more efficient.

### Fourth Embodiment

In the above first to third embodiments, the image recognition system 200 has been described as executing the compression/reconstruction/recognition process after the transition to the recognition phase. Meanwhile, it is conceivable that the recognition accuracy and the total value f the processing time may fluctuate due to changes in the input image data and network conditions after the transition to the recognition phase.

Thus, in a fourth embodiment, in the case of using the learned autoencoder 710 that has been learned in the third embodiment, the function of adjusting the recognition accuracy and the total value of the processing time after the transition to the recognition phase is added to an edge device 260 and a cloud device 270. Hereinafter, the fourth embodiment will be described.

[Functional Configuration of Edge Device and Cloud Device]

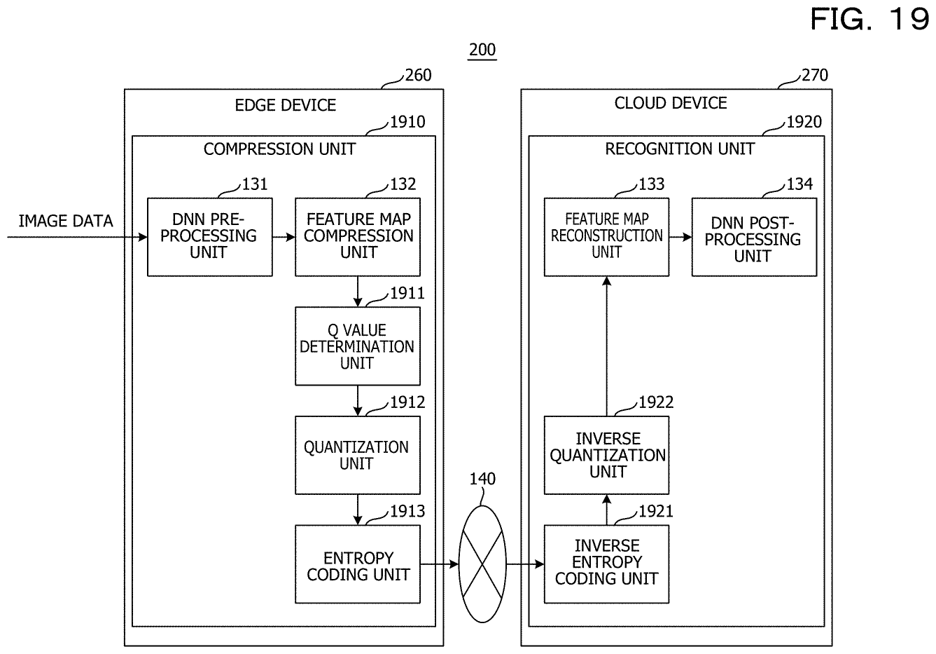

First, the functional configuration of the edge device 260 and the cloud device 270 of an image recognition system 200 according to the fourth embodiment in the “recognition phase” will be described. FIG. 19 is a second diagram illustrating an example of the functional configuration of the edge device and the cloud device.

The difference from the functional configuration described with reference to FIG. 12 is that the edge device 260 includes a compression unit 1910, and the compression unit 1910 includes a Q value determination unit 1911, a quantization unit 1912, and an entropy coding unit 1913.

Furthermore, the difference from the functional configuration described with reference to FIG. 12 is that the cloud device 270 includes a recognition unit 1920, and the recognition unit 1920 includes an inverse entropy coding unit 1921 and an inverse quantization unit 1922.

The Q value determination unit 1911 determines a Q value for when coding the feature maps compressed by a feature map compression unit 132. The Q value determination unit 1911 monitors the code amount during the recognition process and the recognition accuracy and determines an appropriate Q value.

The quantization unit 1912 quantizes the compressed feature maps using the Q value determined by the Q value determination unit 1911.

The entropy coding unit 1913 performs an entropy coding process on the compressed feature maps quantized using the determined Q value and generates a coded stream. In addition, the entropy coding unit 1913 transmits the generated coded stream to the cloud device 270 via a network 140.

The inverse entropy coding unit 1921 performs an inverse entropy coding process on the transmitted coded stream.

The inverse quantization unit 1922 performs an inverse quantization process on the coded stream subjected to the inverse entropy coding process and decodes the compressed feature maps.

[Flow of Compression/Reconstruction/Recognition Process by Edge Device and Cloud Device]

Next, a flow of a compression/reconstruction/recognition process by the edge device 260 and the cloud device 270 of the image recognition system 200 according to the fourth embodiment in the “recognition phase” will be described.

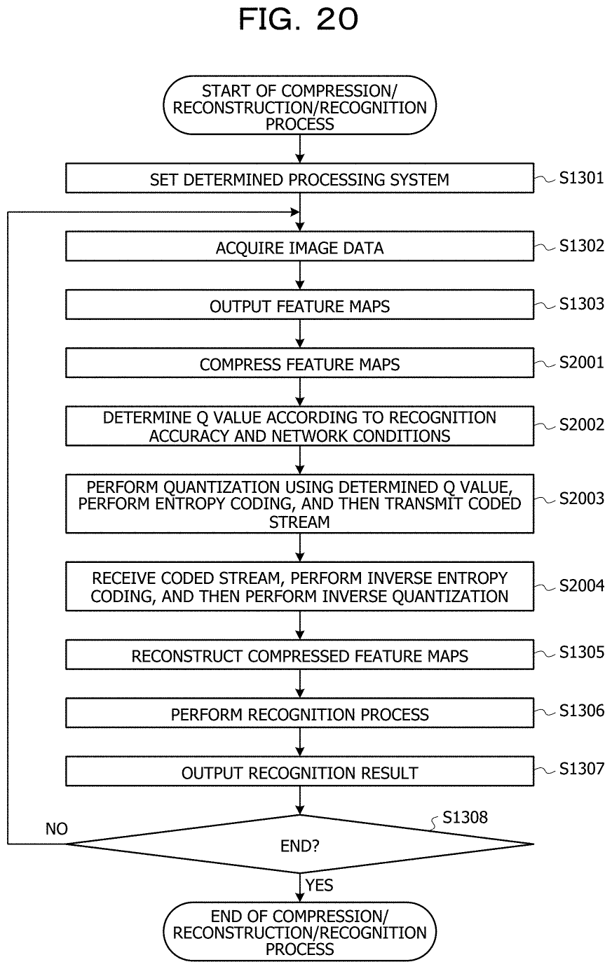

FIG. 20 is a second flowchart illustrating a flow of the compression/reconstruction/recognition process by the edge device and the cloud device. The differences from the flowchart described with reference to FIG. 13 in the above first embodiment are operations S2001 to S2004.

In operation S2001, in the compression unit 1910 of the edge device 260, the feature map compression unit 132 compresses the output feature maps.

In operation S2002, in the compression unit 1910 of the edge device 260, the Q value determination unit 1911 determines the Q value for when coding the feature maps compressed by the feature map compression unit 132, according to the recognition accuracy and the network conditions (the code amount of the coded stream based on the recognition accuracy and the network conditions).

In operation S2003, in the compression unit 1910 of the edge device 260, the quantization unit 1912 quantizes the compressed feature maps using the Q value determined by the Q value determination unit 1911. In addition, the entropy coding unit 1913 performs the entropy coding process on the compressed feature maps that have been quantized to generate a coded stream and then transmits the generated coded stream to the cloud device 270.

In operation S2004, in the recognition unit 1920 of the cloud device 270, the inverse entropy coding unit 1921 receives the coded stream and, after performing the inverse entropy coding process, decodes the compressed feature maps by performing the inverse quantization process.

As described above, in the fourth embodiment, when the compressed feature maps are transmitted, the coded stream is transmitted by quantizing under the determined Q value and performing the entropy coding process. At this time, in the fourth embodiment, the Q value is determined based on the code amount of the coded stream based on the network conditions and the recognition accuracy when the recognition process is performed in the cloud device 270.

Consequently, according to the fourth embodiment, the recognition accuracy and the code amount (for example, the transmission time) may be adjusted in the recognition phase.

### Other Embodiments

In the above first embodiment, it has been described that the feature maps compressed by the feature map compression unit 132 are transmitted. However, the transmission method by the compression unit 261 is not limited to this, and as in the above fourth embodiment, a coded stream generated by performing a quantization process on the compressed feature maps using a predetermined Q value and additionally performing the entropy coding process may be transmitted. In the case of the first embodiment, however, “1.0” is set as the predetermined Q value. This is because, since the learned autoencoder that is learned in the first embodiment is not an orthonormal autoencoder, the amount of data and the deterioration of recognition accuracy may not be controlled based on the Q value when the quantization process is performed.

Note that, when the coded stream is transmitted, the time for the compression process by the feature map compression unit 132 (compression processing time) calculated in the evaluation phase will include the time for the quantization process and the entropy coding process. In addition, the time for the reconstruction process by the feature map reconstruction unit 133 (reconstruction processing time) will include the time for the inverse entropy coding process and the time for the inverse quantization process. Furthermore, the transmission time will be calculated as the time for transmitting the coded stream.

In addition, although a specific example of the autoencoder 710 has not be mentioned in each of the above embodiments, the autoencoder 710 may be, for example, a convolutional autoencoder (CAE). Alternatively, the autoencoder 710 may be, for example, a variational autoencoder (VAE). Alternatively, the autoencoder 710 may be, for example, a recurrent neural network (RNN) or a generative adversarial network (GAN).

Note that the embodiments are not limited to the configurations described here and may include, for example, combinations of the configurations or the like described in the above embodiments with other elements. These points may be altered without departing from the spirit of the embodiments and may be appropriately defined according to application modes thereof.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An image recognition system comprising:
at least one memory; and
at least one processor coupled to the at least one memory, respectively, and configured to:
perform a first process, for an image inputted, up to a dividing position determined in a deep neural network (DNN), and output feature maps of the image;
compress the outputted feature maps, and transmit the compressed feature maps;
receive and reconstruct the compressed feature maps; and
perform a recognition process, for the reconstructed feature map inputted, after the dividing position, and output a recognition result,
wherein the dividing position is determined by accuracy of the recognition result and a total time that includes a time for the performing of the first process, a time for the compressing of the outputted feature maps, a time for the transmitting of the compressed feature maps, a time for the reconstructing of the compressed feature maps, and a time for the performing of the recognition process.

2. The image recognition system according to claim 1, wherein the dividing position is determined by the accuracy of the recognition result and the total time for each of a plurality of candidate dividing positions.

3. The image recognition system according to claim 1, wherein the compressing of the outputted feature maps and the reconstructing of the compressed feature maps are learned so as to minimize a cost obtained based on an error between the recognition result when the image for learning is inputted and a ground truth of the image for learning, and based on entropy that indicates an amount of data of the compressed feature maps when the image for learning is inputted.

4. The image recognition system according to claim 1,
wherein the compressing of the outputted feature maps includes generating a coded stream by performing an entropy coding process for the compressed feature maps quantized by a predetermined quantization value, and
wherein the code stream is transmitted.

5. An evaluation device comprising:
a memory; and
a processor coupled to the memory and configured to:
include at least one processing system, the processing system
performing a first process, for an image inputted, up to candidate dividing positions determined in a deep neural network (DNN), and outputting feature maps of the image,
compressing the outputted feature maps, and transmitting the compressed future,
reconstructing the compressed feature maps, and
performing a recognition process, for the reconstructed feature map inputted, after the dividing position, and outputting a recognition result, and
determine a single processing system among a plurality of processing systems that includes the at least one processing system, by accuracy of the recognition result and a total time that includes a time for the performing of the first process, a time for the compressing of the outputted feature maps, a time for the transmitting of the compressed feature maps, a time for the reconstructing of the compressed feature maps, and a time for the performing of the recognition process,
wherein the accuracy of the recognition result and the total time are obtained for the plurality of the processing systems based on each of a plurality of the candidate dividing positions different from each other.

6. The evaluation device according to claim 5, wherein the candidate dividing positions are determined based on computing power of a device in which the performing of the first process and the compressing of the outputted feature maps are set.

7. The evaluation device according to claim 5, wherein the candidate dividing positions are determined among layers that cause changes in a size of the feature map, among the respective layers included in the DNN.

8. The evaluation device according to claim 7, wherein the candidate dividing positions are determined among the layers of an input side of the layers at which a process branches, among the respective layers included in the DNN.

9. The evaluation device according to claim 5, wherein the compressing of the outputted feature maps and the reconstructing of the compressed feature maps are learned so as to minimize a cost obtained based on an error between the recognition result when the image for learning is inputted and a ground truth of the image for learning, and based on entropy that indicates an amount of data of the compressed feature maps when the image for learning is inputted.

10. The evaluation device according to claim 9, wherein the processor is further configured to:
when plural the compressing of the outputted feature maps and plural the reconstructing of the compressed feature maps are generated by learning while changing a weighting factor used when obtaining the cost based on the error and the entropy,
first identify the processing systems of which the accuracy of the recognition result is equal to or higher than a predetermined tolerance value, among the plurality of the processing systems that include any of the plural compressing of the outputted feature maps and the plural reconstructing of the compressed feature maps that have been generated; and
second identify the single processing system that minimize the total time, among the first identified processing systems.

11. The evaluation device according to claim 5, wherein the compressing of the outputted feature maps and the reconstructing of the compressed feature maps are learned so as to minimize the cost obtained based on
a first error between a first recognition result when the image for learning is inputted and the ground truth of the image for learning,
a second error between the first recognition result and a second recognition result obtained by the reconstructing of the compressed feature maps after adding noise to the compressed feature maps when the image for learning is inputted and by the performing of the recognition process, and
entropy that indicates an amount of data of the compressed feature maps when the image for learning is inputted.

12. An image recognition method comprising:
performing a first process, for an image inputted, up to a dividing position determined in a deep neural network (DNN), and output feature maps of the image;
compressing the outputted feature maps, and transmit the compressed feature maps;
receiving and reconstructing the compressed feature maps; and
performing a recognition process, for the reconstructed feature map inputted, after the dividing position, and output a recognition result, by at least one processor,
wherein the dividing position is determined by using accuracy of the recognition result and a total time that includes a time for the performing of the first process, a time for the compressing of the outputted feature maps, a time for the transmitting of the compressed feature maps, a time for the reconstructing of the compressed feature maps, and a time for the performing of the recognition process.
